(19) United States
(12) Patent Application Publication
(10) Pub. No.: US 2026/0045108 A1
(43) Pub. Date: Feb. 12, 2026

(54) Systems and methods for generating and/or using 3-dimensional information with one or more moving cameras

(71) Applicant: Visionary Machines Pty Ltd, Sydney (AU)

(72) Inventors: Rhys NEWMAN, Sydney (AU); Gary AITCHISON, Sydney (AU)

(73) Assignee: Visionary Machines Pty Ltd, Sydney (AU)

(21) Appl. No.: 19/102,334

(22) PCT Filed: Aug. 9, 2023
(86) PCT No.: PCT/AU2023/050749

§ 371 Date: Feb. 7, 2025

(30) Foreign Application Priority Data
Aug. 9, 2022 (AU) 2022902228

(51) Int. Cl. G06V 20/70; G06T 7/70; G06V 10/12; G06V 10/94; G06V 20/58

(52) U.S. Cl. CPC G06V 20/70; G06T 7/70; G06V 10/12; G06V 10/945; G06V 20/58; G06T 2207/30244; G06T 2207/30261

(57) ABSTRACT

The present disclosure is directed to devices, systems and/or methods that may be used for generation of spatial annotations using at least one camera array and a computer system. The said camera array comprises a plurality of cameras, and is configured to generate spatial information instance data. The computer system is configured to capture, and associate, a plurality of said spatial information instance data with one or more of the following: image data, sensor data, and user entered data. Exemplary embodiments may be used for determining scene information using data obtained, at least in part, from one or more moving cameras. That scene information may be 3D information.

### FIELD

The present disclosure relates generally to devices, systems and/or methods that may be used for determining scene information using data obtained at least in part from one or more moving cameras. That scene information may be 3D information.

### BACKGROUND

Scene information about the 3D environment is useful for many applications including, for example, the safe autonomous driving of vehicles, and for example for navigation, surveying, environmental monitoring, crop monitoring, mine surveying, and checking the integrity of built structures. There exist mobile systems that use spatial sensors such as lidar to capture models of the world however lidar does not capture colour information and thus cannot reproduce for a user a representation of a scene in a way that is easily understood but the user. There exist mobile systems for capturing photographic data where that image data is approximately geolocated by GPS (Global Positioning System). And GPS may be used to record the path travelled by a vehicle. However, the accuracy of GPS is limited and in some environments GPS may not be available.

The present disclosure is directed to overcome and/or ameliorate at least one or more of the disadvantages of the prior art, as will become apparent from the discussion herein. The present disclosure also provides other advantages and/or improvements as discussed herein.

### SUMMARY

Certain embodiments are to devices, methods and/or systems comprising:
at least one camera array comprising at least 2 cameras; wherein the camera array is configured to generate spatial information instance data;
a computer system that is configured to:
   capture a plurality of spatial information instance data and one or more of the following: image data, sensor data, and user entered data;
   and associate the one or more of the following: image data, sensor data, and user entered data with the plurality spatial information instance data captured.

Certain embodiments are to devices, methods and/or systems for generation of spatial annotations comprising: at least one camera array comprising at least 4, 5, 6, 8, 10, 12, 14, or 16 cameras; wherein at least 4 cameras, of the at least one camera array, is a sensor that is sensitive to an electromagnetic spectrum and configured to generate spatial information instance data;
a computer system that is configured to:
   capture a plurality of spatial information instance data and one or more of the following: image data, sensor data, and user entered data;
   determine a path for the plurality spatial information instance data captured; and
   associate the one or more of the following: image data, sensor data, and user entered data with the plurality spatial information instance data captured.

Certain embodiments are to devices, methods and/or systems for generation of spatial annotations, wherein the computer system is further configured to determine one or more pose changes using one or more of the following: image data and spatial information instance data; and compute the path using the one or more pose changes.

Certain embodiments are to devices, methods and/or systems for generation of spatial annotations, wherein the computer system further comprises a user interface that is configured to: allow an annotation with a location in three-dimensions, and present spatial information where the user interface permits changing the point of view, and where the user interface permits a user to select a point or surface represented in the spatial information that is representative of a physical surface in the spatial information; wherein the user interface permits the user to associate a point or surface with an annotation.

Certain embodiments are to devices, methods and/or systems for generation of spatial annotations, wherein a computer is configured to: operate on information from the sensor to identify an object of interest, and permits an annotation for a location in three-dimensions using information from the computer system.

Certain embodiments are to devices, methods and/or systems for generation of spatial annotations, wherein the computer system further comprises a user interface that is configured to:
determine a geo-referenced location from at least one reference point with a known geo-referenced location and one or more pose changes, wherein the one or more pose changes is determined using one or more of the following: spatial data and image data;
present spatial information where the user interface that allows for changing the point of view, and allow a user to select a point or surface represented in the spatial information that is representative of a physical surface in the spatial information, and allows the user to associate a point or surface with an annotation.

Certain embodiments are to method for generation of spatial annotations using any

Certain embodiments are directed to one or more computer-readable non-transitory storage media embodying software that is operable when executed using any of the systems and/or methods disclosed herein.

### BRIEF DESCRIPTION OF DRAWINGS

FIG. 1 shows an overall system diagram including sensor unit and explorer unit, according to at least one embodiment.

FIG. 2 shows a main representation of the process flow, according to at least one embodiment.

FIG. 3 shows a user interface for the sensor unit including a map panel and a spatial sensor panel, according to at least one embodiment.

FIG. 4 shows the structure of a trace and associated sequence of elements, according to at least one embodiment.

FIG. 5 shows some examples of elements and associated data blocks, according to at least one embodiment.

FIG. 6 shows some further elements and associated data blocks including additional types of data block, according to at least one embodiment.

FIG. 7 shows some further examples of elements and associated data blocks including annotation data blocks, according to at least one embodiment.

FIG. 8 shows a user interface for the sensor unit including manual placing of position markers on a map and manually adding a 3D annotation, according to at least one embodiment.

FIG. 9 provides examples of part of the user interface display when showing measurements, according to at least one embodiment.

FIG. 10 provides examples of part of the user interface display when showing measurements, according to at least one embodiment.

FIG. 11 shows a user interface for the explorer unit including a map panel and a spatial sensor panel, according to at least one embodiment.

FIG. 12 shows an alternative user interface modes for an explorer unit, according to at least one embodiment.

FIG. 13 shows a further alternative user interface modes for an explorer unit, according to at least one embodiment.

FIG. 14 is an illustration of an exemplary real-world scene.

FIG. 15 is an illustration of an exemplary computer system.

FIG. 16 is an illustration of exemplary camera array, according to at least one embodiment.

### DETAILED DESCRIPTION

The following description is provided in relation to several embodiments that may share common characteristics and features. It is to be understood that one or more features of one embodiment may be combined with one or more features of other embodiments. In addition, a single feature or combination of features in certain of the embodiments may constitute additional embodiments. Specific structural and functional details disclosed herein are not to be interpreted as limiting, but merely as a representative basis for teaching one skilled in the art to variously employ the disclosed embodiments and variations of those embodiments.

The subject headings used in the detailed description are included only for the ease of reference of the reader and should not be used to limit the subject matter found throughout the disclosure or the claims. The subject headings should not be used in construing the scope of the claims or the claim limitations.

Certain embodiments of this disclosure may be useful in a number of areas. For example, one or more of the following non-limiting exemplary applications: off-road vehicle (e.g., cars, buses, motorcycles, trucks, tractors, forklifts, cranes, backhoes, bulldozers); road vehicles (e.g., cars, buses, motorcycles, trucks); rail based vehicles (e.g., locomotives); air based vehicles (e.g., airplanes), space based vehicles (e.g., satellites, or constellations of satellites); individuals (e.g., miners, soldiers, war fighters, rescuers, maintenance workers), amphibious vehicles (e.g., boats, cars, buses); and watercraft (e.g., ships boats, hovercraft, submarines). In addition, the non-limiting exemplary applications may be operator driven, semi-autonomous and/or autonomous. Further applications may include navigation, autonomous vehicle navigation, surveying, surveillance, reconnaissance, intelligence gathering, environmental monitoring, and infrastructure monitoring.

The term “scene” means a subset of the three dimensional real-world (i.e., 3D physical reality) as perceived through the field of view of one or more cameras or other sensors. In certain embodiments, there may be at least 1, 2, 3, 4, 5, 10, 15, 20, 25, 30, 35 or 40, 100, 1000, or more cameras and or other sensors.

The term “object” means an element in a scene. For example, a scene may include one or more of the following objects: a person, a child, a car, a truck, a crane, a mining truck, a bus, a train, a motorcycle, a wheel, a patch of grass, a bush, a tree, a branch, a leaf, a rock, a hill, a cliff, a river, a road, a marking on the road, a depression in a road surface, a snow flake, a house, an office building, an industrial building, a tower, a bridge, an aqueduct, a bird, a flying bird, a runway, an airplane, a helicopter, door, a door knob, a shelf, a storage rack, a fork lift, a box, a building, an airfield, a town or city, a river, a mountain range, a field, a jungle, and a container. An object may be a moving element or may be stationary or substantially stationary. An object may be considered to be in a background or a foreground.

The term “physical surface” means the surface of an object in a scene that emits and/or reflects electromagnetic signals in at least one portion of the electromagnetic spectrum and where at least a portion of such signals travel across at least a portion of the scene.

The term “3D point” means a representation of the location of a point in the scene defined at least in part by at least three parameters that indicate distance in three dimensions from an origin reference to the point, for example, in three directions from the origin where the directions may be substantially perpendicular (at least not co-planar or co-linear), or as an alternative example using a spherical coordinate system consisting of a radial distance, a polar angle, and an azimuthal angle.

The term “camera” means a device that comprises an image sensor, an optional filter array and a lens (or a plurality of lenses) that at least partially directs a potentially limited portion of incoming electromagnetic signals onto at least some of the sensor elements in an image sensor. The lens, for example, may be a pin hole, an optical lens, a diffractive grating lens or combinations thereof. In certain embodiments a camera may be an imaging device that can image from electromagnetic signals in one or more bands including for example visible, ultraviolet, infra-red, short-wave infra-red (SWIR).

The term “each” as used herein means that at least 95%, 96%, 97%, 98%, 99% or 100% of the items or functions referred to perform as indicated. Exemplary items or functions include, but are not limited to, one or more of the following: location(s), image pair(s), cell(s), pixel(s), pixel location(s), layer(s), element(s), neighbourhood(s), point(s), 3D neighbourhood(s), and 3D point(s).

The term “at least a substantial portion” as used herein means that at least 60%, 70%, 80%, 85%, 95%, 96%, 97%, 98%, 99%, or 100% of the items or functions referred to. Exemplary items or functions include, but are not limited to, one or more of the following: location(s), image pair(s), cell(s), pixel(s), pixel location(s), layer(s), element(s), point(s), neighbourhood(s), 3D neighbourhood(s), and 3D point(s).

The term “real-time” means processing may be sufficiently fast that resulting information may be used for making decisions substantially at the time of operation. Non-limiting examples may be for applications on one or more of the following: a car, a truck, a train, an airplane, a helicopter, a drone, a satellite, a tractor, a ship, mobile farm or mining equipment, a fixed crane or observation point (e.g., security viewpoint) or a boat where real-time processing may be processing that may be performed within 100 minutes, 10 minutes, 1 minute, 1 second, 100 ms, 10 ms, 1 ms or other value appropriate to the situation.

The term “pose” means the location and orientation of an object, sensor or collection of sensors. The location and orientation may be described by a set of parameters and the set of parameters used may depend on the coordinate system being used. For example, in a cartesian coordinate system the parameters may be comprise six numbers, three for the location being described by X, Y, X coordinates and three being for the orientation being described by rotation from the reference axis in degrees for pan, tilt, roll. The pose can be described by rotation and translation transformations from an origin. The rotation and translate transforms may be represented in a matrix.

The term “pose change” means the change in the location and/or orientation of an object, sensor or collection of sensors. The pose change can be described by means of a rotation and translation transformations. The rotation and translate transforms may be represented in a matrix.

The term “3D neighbourhood” means a 3D volume in the scene whose maximum linear extent in one or more directions is limited to be less than a specified threshold. That threshold, which may be different for different directions, may be, for example, 0.1 mm, 1 mm, 5 mm, 1 cm, 5 cm, 10 cm, 50 cm, 1 m, 5 m, 10 m, 50 m, 100 m, or other value of appropriate scale when considering the overall size of the physical space represented by the scene. A 3D neighbourhood may be considered to contain one or more 3D points if the coordinates of those points lie within the 3D volume described by that 3D neighbourhood. Discussion and/or calculations that refer to 3D neighbourhoods in the present disclosure may apply to single 3D points.

The term “spatial information” means information about a scene where information about one or more 3D points and/or 3D neighbourhoods in the scene may optionally include none or one or more of: i) a characteristic location of the 3D neighbourhood (e.g., the arithmetic or geometric centroid of the 3D points contained in the neighbourhood); ii) the spectral information regarding the appearance of one or more points contained in the neighbourhood from the viewpoint of one or more cameras; and iii) a set of metadata that describe, at least in part, the points contained in the neighbourhood. The set of metadata may include one or more of the following properties: the texture of the points; spectral data from a region near the points; the instantaneous velocities of one or more points in one, two, or three dimensions (also allowing for one or more summarized velocity values such as the average velocity of the points in one, two, or three dimensions); the type or classification of object wholly or partially present in the 3D neighbourhood; and other data.

The term “spatial information instance” means spatial information about a scene during a relatively static time period. A lidar and/or a camera array spatial sensor may deliver a spatial information instance.

The term “accumulated spatial information” means spatial information generated by the transformation of data from two or more spatial information instances. Suitable transforms may be applied to ensure alignment of the spatial information instances to a common frame of reference.

The term “geo-referenced location” means a location that describes a particular location on or about the earth. A geo-referenced location may be described in terms of a known earth-based coordinate system, for example, longitude, latitude, and/or altitude or for a second example earth-centered, earth-fixed coordinate system (ECEF).

The term “path” means the set of locations that an object (that may be a vehicle or a sensor and/or other object) passes through over a period of time. A path may be described by a set of in locations in three-dimensional space or by a set of locations in two-dimensional space over a surface such as the surface of the earth and as may be illustrated on a map.

### Certain Exemplary Advantages

In addition to other advantages disclosed herein, one or more of the following advantages may be present in certain exemplary embodiments:

One advantage may be that spatial information may be annotated with precise reference to locations in three-dimensional space overcoming (or substantially overcoming) errors and/or inaccuracies that may occur when attempting to position annotations and/or measurement points in three-dimensional space using a two dimensional view available on a user interface.

Another advantage may be that spatial information, path and/or annotations may be accurately (or substantially accurately) geo-referenced in environments where global positioning systems may not be available. For example, when operating inside a building or in an underground mine or in when global positioning systems have been disabled.

Another advantage may be that sensor information may be associated with spatial information and/or time information and may be searched, filtered and/or accessed. In addition, the data may be refined for improvement such as increased accuracy or processed for new functions such as to apply AI methods to find particular types of objects and these may be determined and located in three-dimensional space.

### System Diagram

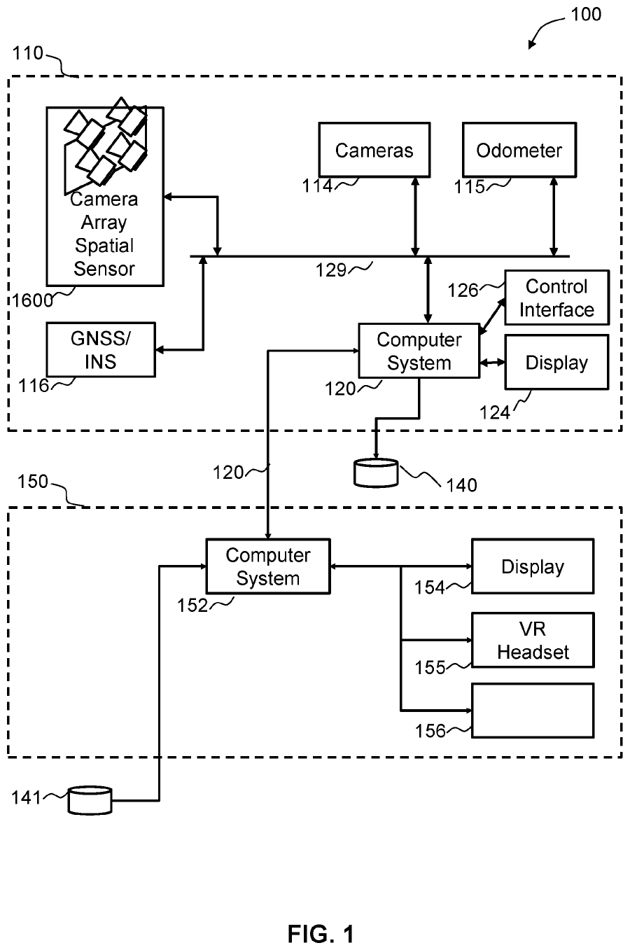

FIG. 1 shows an exemplary system 100 including a sensor unit 110 and an explorer unit 110. The sensor unit 110 may support the capture of data about a scene from multiple sensors and display of data about a scene. The explorer unit 150 may support further processing of data, selecting data for review and further presenting of data.

The sensor unit 110 may comprise multiple sensors including a camera array spatial sensor 1600, camera 114, odometer 115, and GNNS/INS 116. The sensor unit may also include other sensors (not illustrated) such as sensors for temperature, barometric pressure, sound recording, radio signal strength, gas analysis, and others. The sensor unit 110 may have a computer system 120. Computer system 120 may operate the sensors 1600, 114, 115, 116 and other with control signals via a communication connection illustrated by 129 as needed and may receive sensor data also via a communication connection 129. The communication connection 129 may depend on the sensors and may be different for different sensors and may include wired connections such as ethernet cable (coaxial, or twisted pair) or serial cable or a wireless connection such as WiFi, bluetooth or other radio communications method. The sensor unit 110 may be equipped for communication to one or more explorer systems 150 illustrated by the communication connection 120. The connection 120 may be a wired connection such as ethernet cable or a wireless connection such as WiFi and/or radio and/or laser. In certain embodiments a data store (140) may be a portable storage device and may be used to store data captured from one or more of the connected sensors.

The sensor unit (110) may include a display 124 that displays a user interface so that a user of the sensor unit 110 can monitor the operation of the sensor unit 110 and perform other operations on the sensor unit 110 as described further in this disclosure. The computer system 120 may be connected to a control interface 126 which may include a keyboard, computer mouse, touch screen, game controller and/or other input devices for operating a user interface. Removable data store 140 that may be used as an alternative way to transfer data between a sensor unit 110 and explorer unit 150.

The explorer unit 150 may receive data from the sensor unit 110 via communication connection 120. A computer system 152 may itself include internal storage 1520 that may be used to record data received from the sensor unit 110. The computer system 152 may operate on the data in the Storage 1520 in various ways including processing the data to generate modified or new data, selecting data, displaying data on a display 154 or displaying data on a VR headset 155. An operator of the explorer unit (150) may provide input with a control interface 156 which may include a keyboard, computer mouse, touch screen, game controller and/or other input device for operating a user interface. The computer system 152 may be connected to a removable data store 141 that may be used both as an alternative mechanism to transfer data between a sensor system 110 and explorer system 150.

### Main Flow

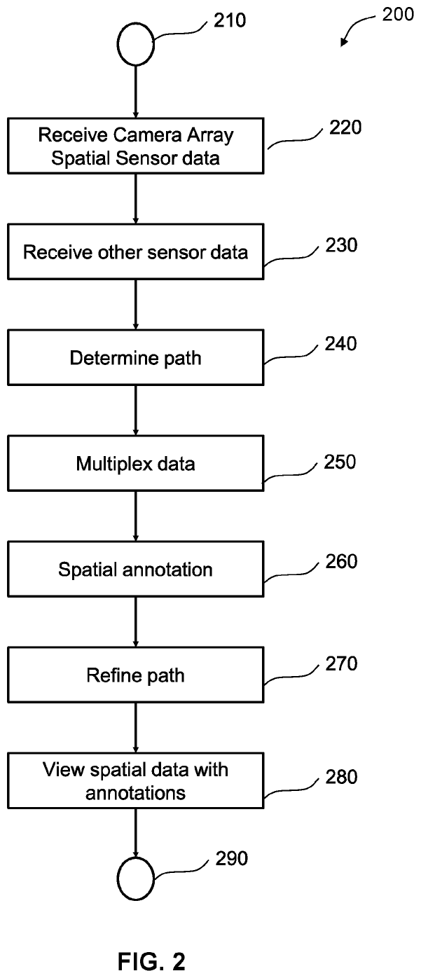

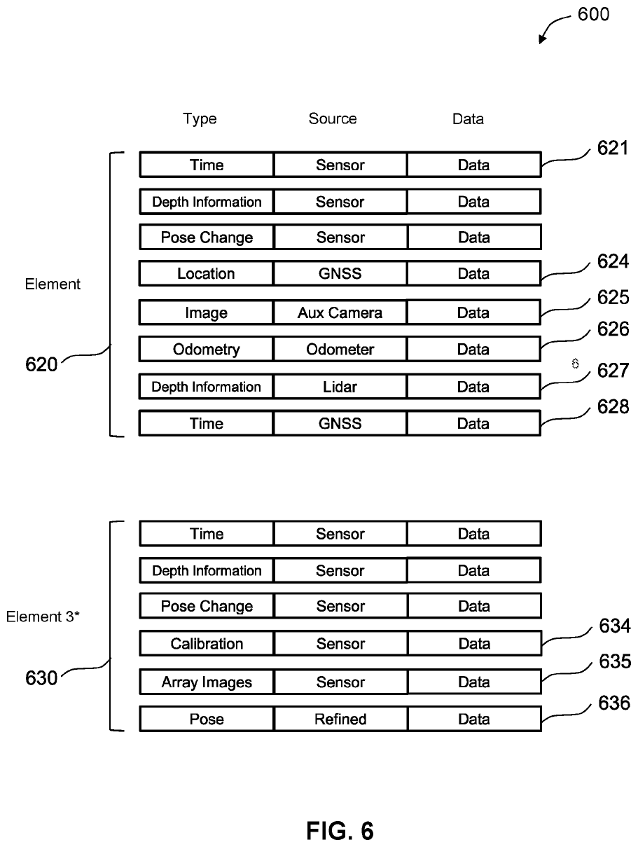

FIG. 2 shows an exemplary main process 200 that may operate on the exemplary system 100. Starting at 210 the process proceeds to step Receive Camera Array Spatial Sensor Data 220 where a spatial information instance is generated by the camera array spatial sensor 300. The spatial information instance may be in the form of a point cloud or a depth map or some other three-dimensional representation of the scene. The spatial information instance is received by computer system 120 from the camera array spatial sensor 300 via communications connection 129. The computer system 120 may store the spatial information instance into its internal memory 1540 or into internal data storage 1520. Typically, the spatial information instance may be generated and received by the computer system frequently at a regular rate. In certain embodiments, spatial information instance from the camera array spatial sensor may be generated, received, or stored at a rate of 1, 2, 5, 10, 20 or 30 times per minute or 1, 2, 5, 10, 20, 30 times per second. The computer system 120 may display a representation of a recently received spatial information instance on the display 123. The computer system 120 may allow a user to control the presentation of the spatial information instance on the display including for example changing the point of view and/or scale and/or colourization. An example of a user interface for the sensor unit 110 is shown in FIG. 6 at 600 and is further described elsewhere in this specification.

From step Receive Camera Array Spatial Sensor Data 220 the process moves to step Receive Other Sensor Data 230. At step Receive Other Sensor Data 230 data captured from other sensors he's received by computer system 120 via communications connection 129. In certain embodiments, the data may include image data from cameras 114, motion data from odometers 115 or location data from GNNS 116. Data may be generated at a rate depending on the sensor type. The computer system 120 may store the other sensor information into its internal memory 1540 or into internal data storage 1520. The computer system 120 may display a representation of the other information on the display 123 as part of the Sensor User Interface 600.

From step Receive Other Sensor Data 230 the process moves to step Determine path 240. At step Determine path 240 the pose change, of the sensor unit 110 is estimated. In certain embodiments, the pose change is determined by methods such as visual synchronous localisation and/or mapping (VSLAM) using camera image information from the camera array spatial sensor 300 and/or from auxiliary cameras 114. In certain embodiments, the pose change is determined using the spatial information instance from the camera array spatial sensor 300. In certain embodiments, the pose change is determined using the spatial information instance from the camera array spatial sensor 300 and image data from the camera array spatial sensor 300. In certain embodiments, the pose change is determined using data from a GNNS/INS sensor 116. In certain embodiments, the pose change is determined using data from the user. In certain embodiments, the pose change is determined using data from an odometry sensor 115.

As the sensor system 110 moves through a scene 1400 the various sensors repeatedly capture information about the scene including spatial information instance and repeatedly determine the pose changes.

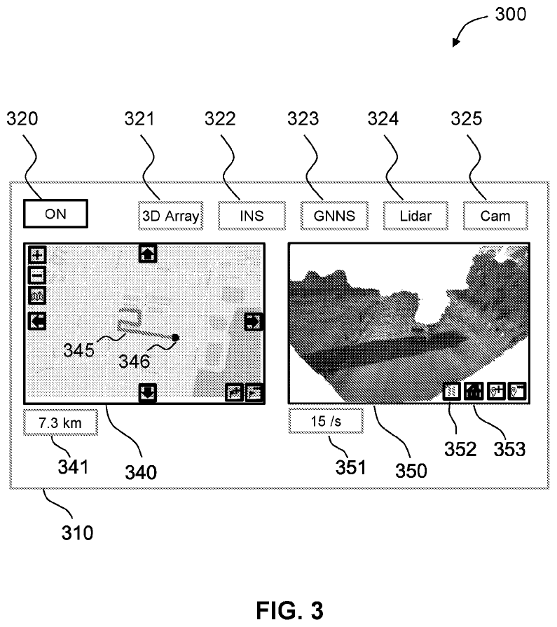

The complete sequence of pose changes may be used to determine a path travelled by the sensor system 110 as it travels through the scene and the path may be illustrated on a map as a trail 345 in the Sensor User Interface 300 (FIG. 3) as presented on the display 123. The collection of pose changes may be further used with the collection of spatial information instance from the camera array spatial sensor to generate accumulated spatial information. In certain embodiments, the spatial sensor 110 may traverse the scene 1400 and the spatial sensor 110 may determine accumulated spatial information representing a portion of the scene. In certain embodiments, the spatial sensor 110 may traverse the scene 1400 multiple times and may traverse the scene in different directions and the spatial sensor 110 may determine accumulated spatial information representing an extensive portion of the scene. In certain embodiments, the accumulated spatial information may be shown on the display 123 as part of the Sensor User Interface 300. The Sensor User Interface and is described in further detail elsewhere in this specification.

From step Determine path 240 the process may move to step Multiplex data 250. At step Multiplex data 250 spatial information instance received from camera Array spatial sensor 300 and/or data received from other sensors may be assembled into multiplexed data. The structure of the multiplexed data is designed facilitate the use of the contained information by the sensor unit 110 and explorer unit 150. Data from other sensors and assembled into multiplexed data may include data from auxiliary camera 114, odometer 115, GNNS/INS 116 and/or pose change information and/or other data whether received from a sensor and/or from user input and/or derived by further processing of data from a sensor or from user input or other data. The structure of the multiplexed data is designed facilitate the use of the contained information by the sensor unit 110 and explorer unit 150. The multiplexed data may be recorded in computer system 120 to a Memory Unit 1540, to a data store 1520, and/or other storage. The structure of the multiplexed data is described elsewhere in this specification.

From step Multiplex data 250 the process moves to step Spatial annotation 260. At step Spatial annotation 260 annotations are generated by the user through interaction with the user interface 600 or by automated operations on the computer system 120. In certain embodiments, the user may select a location in the observed scene 1400 using the user interface 600 and provide an annotation for that location in the observed scene 1400. The location may be a three-dimensional position in a coordinate space local to the sensor unit 110. The location may be a three-dimensional position in a global, geo-referenced coordinate system. The annotation may be text entered by the user. The annotation may be a symbol and/or label selected by the user from a set of symbols or labels. The annotation may be a voice recording of the user. The annotation may be a measurement made by interacting with the user interface 600 and based on the spatial information. The annotation may be associated with two or more three-dimensional positions. In certain embodiments, the annotation may be associated with a three-dimensional volume. In certain embodiments, the annotation may be associated with an object. The annotation may be recorded by the computer system 120 to its memory 1540 or internal data store 1520 and associated with the selected location and with the spatial information. In certain embodiments, the annotation may be appended to the multiplex data associated with spatial information instance being annotated by the user.

In certain embodiments annotation may be based on information generated by AI processes operating on the computer system 120. These AI processes may include object detection and/or object classification, for example, to locate objects such as cars, buses, trucks, people, trees, shrubs, gates, buildings, signs, traffic lights, potholes, roundabouts, intersections, bridges, overpasses and/or other objects of interest depending on the application. In certain embodiments, the generated annotation may include a label describing the classification of the object detected. In certain embodiments, the annotation may include an image captured by one of the auxiliary cameras 114 or a camera from the camera array spatial sensor 300. In certain embodiments, the generated annotation may include other information collected from sensors in the sensor system 110. In certain embodiments, the location of the detected object is mapped from a 2D image, from one of the auxiliary cameras 114 or from a camera from the camera array spatial sensor 300, to the spatial information data to determine the object's location in the scene 1400. The object annotation may be recorded by the computer system 120 to its memory 1540 or internal data store 1520 and associated with the objects location and with the spatial information data.

In certain embodiments, the multiplexed data may be uploaded from the Spatial Sensor 110 to the explorer unit 150 via communications connection 120. In certain embodiments multiplexed data may be transmitted from the Spatial Sensor 110 to the explorer unit 150 via communications connection 120 as a stream of data in real-time or in substantially real-time. The computer system 152 may include a data store 1520 that may be a database with indexing to enable querying of extensive volumes of multiplexed data. In some embodiments, the explorer unit 150 may receive multiplex data from one or more sensor unit 110, for example, multiple vehicles may be equipped with sensor unit 110 and may generate multiplexed data and may transmit that data to an explorer unit 150 or may upload that data to an explorer unit when a communication connection becomes operational.

From step Spatial annotation 260 the process moves to step Refine Path annotation 270. At step Refine Path 270 further processing may be performed to generate a new set of pose changes. In certain embodiments, algorithms used in this step may be require more intensive processing that those used at step Determine Path 240. The pose changes may be determined using processing such as VSLAM with high resolution images. In certain embodiments, the step Refine Path 270 is optional. In certain embodiments, the step Refine Path 270 may be performed on the sensor unit 110. In certain embodiments, the step Refine Path 270 mayl be performed on the explorer unit 150 and may take advantage of additional processing capacity available. Once a refined set of pose changes has been determined these may be written to the multiplexed data.

From step Refine path 270 the process may move to step View spatial data with annotations 280. At step View spatial data with annotations 280 a user interface may be presented that allows the user to explore spatial information and find and/or review annotations made to the spatial data. In certain embodiments, the user interface may be presented by the explorer unit 150 on display 154. In certain embodiments, the user interface may be configured to enable the user to search the multiplexed data to find paths recorded at certain period of time, for example, before January 2022, or for example between January 28th 2022, and January 30th 2022. In certain embodiments, the user may filter the displayed paths based on other criteria, for example, based on the type of sensor information available, based on the presence of a specified type of annotation, based on the particular vehicle used to perform the capture, the operator, the day of the week, the time of day, the season, the speed of the vehicle, the direction of travel of the vehicle, other criteria that may be of interest to the user, or combinations thereof. The user interface of the explorer unit and its features are descripted in further detail elsewhere in this specification.

From step View spatial data with annotations 280 the process terminates at 290.

In certain embodiments step View spatial data with annotations 280 may include presentation of a spatial information on a Virtual Reality (VR) headset. A VR headset may include control devices that may enable the user to view the spatial information. The viewing data through a VR headset may provide the user an immersive experience and facilitate their understanding of the scene that was originally captured. The user may make annotations made to the spatial information using the VR headset control devices.

### Multiplexed Data

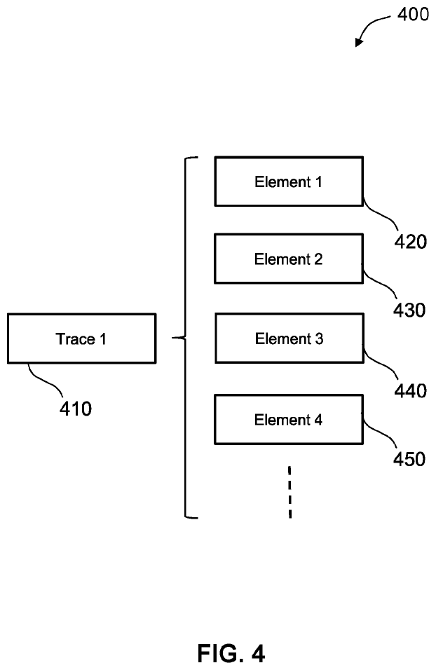

FIG. 4 shows a data structure 400 to organise multiplex data such as may be assembled in step Multiplex data 250. The multiplexed data includes one or more instances of data known as a trace, such as Trace 1 (410), which is conceptually a container for the information associated with single continuous period of operation of the sensor unit 110 as it moves through a scene 1400. A trace contains or is associated with a sequence of elements, such as Element 1 (420), Element 2 (430), etc., where an element contains or is associated with information associated with a particular instance of spatial information captured by the spatial sensor at or around a particular time as the sensor system 110 move though a scene. The sequence of elements may be ordered according to the time that the spatial information was captured. For example, Element 1 (420) may contain data first captured by the sensor unit when the user initiated the system operation and Element 2 (430) may contain the next subsequent set of data captured by the sensor unit. Each Element 420, 430, 440, 450, etc may be associated with information about a portion of a scene 1400 that was observed by the sensor unit 110 at the time the sensor data was captured as the sensor unit passes through the scene. In certain embodiments, one or more traces may be stored in a memory unit 1540, or in a data store 1520. In certain embodiments, the trace may be stored in a database with appropriate indexing to enable rapid querying of extensive volumes of multiplexed data comprising a plurality of trace elements and/or plurality of frame elements.

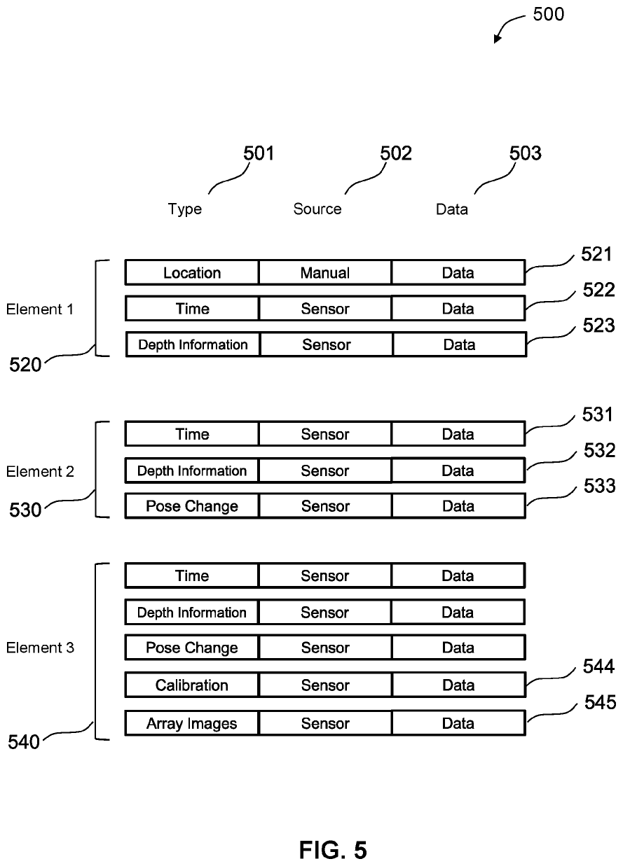

FIG. 5 shows some examples of elements and associated data blocks. The elements are illustrated as Element 1 (520), Element 2 (530) and Element 3 (540). An element may comprise or be associated with a set of data packets indicated by the horizontal rows in this illustration, for example, Element 1 (520) comprises data packets shown in rows at 521, 522, 523. The illustrated data packets may be associated with a particular type of data and the first portion of the illustrated data packets may contain a label ascribing the type of the data as indicted by the column at 501. The type of the data packet may be used to help read data from the data packet as a type of data packet may have a prescribed layout or syntax for the information contained in the data portion of the data packet. Each data packet may also contain a label ascribing a source for the data as indicated by the column at 502. The source may assist in understanding the accuracy and/or reliability or other characteristics of the data contained in the data packet. For example, a location data packet with a source of ‘Manual’ may contain an approximate location perhaps with potentially substantial errors and alternatively a location data packet with a source of ‘GNSS-RTK’ may be expected to have location information that is accurate to a few centimetres. In certain embodiments, location data packet with certain source such as ‘GNSS-RTK’ may be expected to have location information that is accurate to better than 1, 2, 3, 4, 5, 10, 25, or 50 cm. In certain embodiments, data packet may have location information that is accurate to better than between 1 to 2, 2 to 5, 10 to 50 cm.

Each data packet may contain or be linked to or be associated some data as indicated with the column 503. Looking at Element 1 (520) in detail the first data packet 521 has a type of ‘Location’ and a source of ‘Manual’, in this case the information contained in the data portion may be a geo referencing information based on the manual entry of data via the sensor unit user interface and as described elsewhere. The second data packet 522 is of type ‘Time’ and its source is ‘Sensor’ and the data portion may be a timestamp including date and time information and may be from the real time clock of the computer system 120. The third data packet 523 is of type ‘Depth information’ and its source is again ‘Sensor’ and the data portion may be spatial information captured by the Camera Array spatial sensor. Thus, in this example, Element 1 provides spatial information and an associated location and time.

A subsequent element, Element 2 (530) has a similar structure to Element 1 (520) however it does not include location information. Element 2 (530) contains a data packet of type ‘Pose Change’ at 533. A ‘Pose Change’ data packet may include a data portion with pose change information describing a mathematical transform of the location and/or orientation of the sensor unit at the time of Element 1 to the location and orientation of the sensor unit at the time of this Element 2. A sequence of elements that include ‘Pose change’ data packets may allow the computation of a path and combined with one or more location data packet may be sufficient to determine geo-referenced locations for elements in the sequence.

Element 3 (540) has a similar structure to element 2 (530) but in this example includes an additional data packet 544 that contain calibration data for the sensor unit 110. Such calibration data may provide intrinsic calibration and/or extrinsic calibration of sensors including the cameras in the camera array, auxiliary cameras, other sensors that have a directionality (such as lidar sensors, radar sensors, sonar sensors) or combinations thereof. Thus, calibration data may be used to map corresponding points in space between the different sensors. In Element 3 (540) a fifth data packet 545 contains image data from cameras 1620, 1630, 1640 etc. that are part of the camera array spatial sensor 1600. The calibration data in 544 and the image data in 545 may be used generate spatial information. In certain embodiments, the sensor unit 110 may generate spatial information at a reduced accuracy through quantising location, reducing number of points of point cloud data generated, approximating some steps leading to additional noise points in the point cloud, or combinations thereof. Because of memory or processing constraints and the calibration data and image data in such as 544 and 545 may be used on a different platform, such as the explorer unit 150, or at another time such when the sensor unit is otherwise idle, and an alternative spatial information may be calculated with higher accuracy or resolution.

FIG. 6 shows some further examples of data frames and associated data blocks including additional types of data block. In element 620 a data packet 624 contains location data sourced from a GNSS. Data packet 625 contains image data from one of the Aux Camera 114. Data packet 626 contains odometry data from odometer 115. Data packet 627 contains depth information from a lidar source. Data packet 628 contains time information and the source is GNSS. The element 620 contains two data packets with time information, later processing may select which source is selected.

Also, in FIG. 6. is shown Element 3* (630) that may be an updated instance of Element 3 (534) where an additional data packet has been added at 636 containing pose change information that may have been calculated using the calibration data packet 634 and the array images data packet 636.

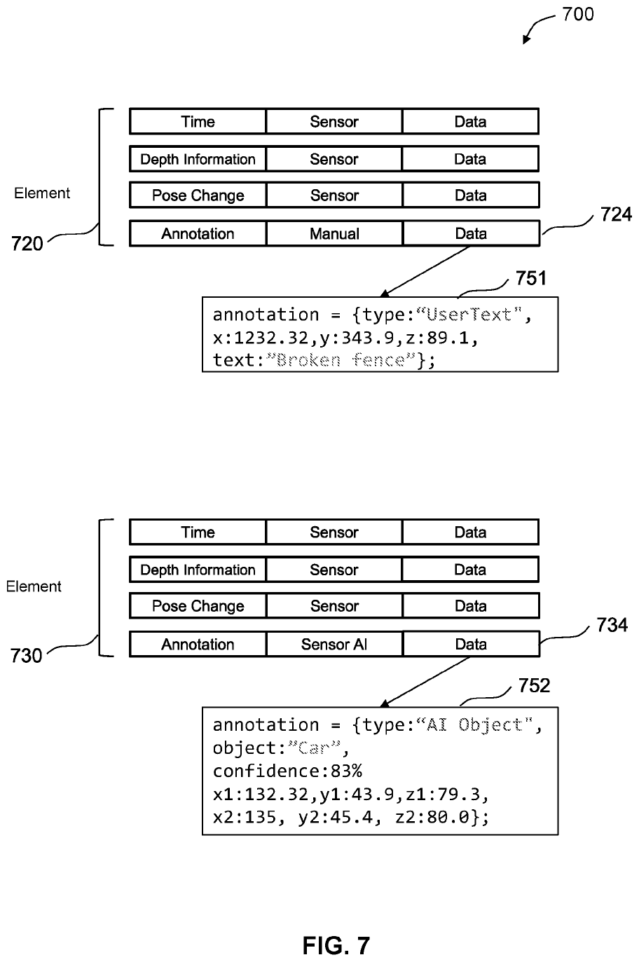

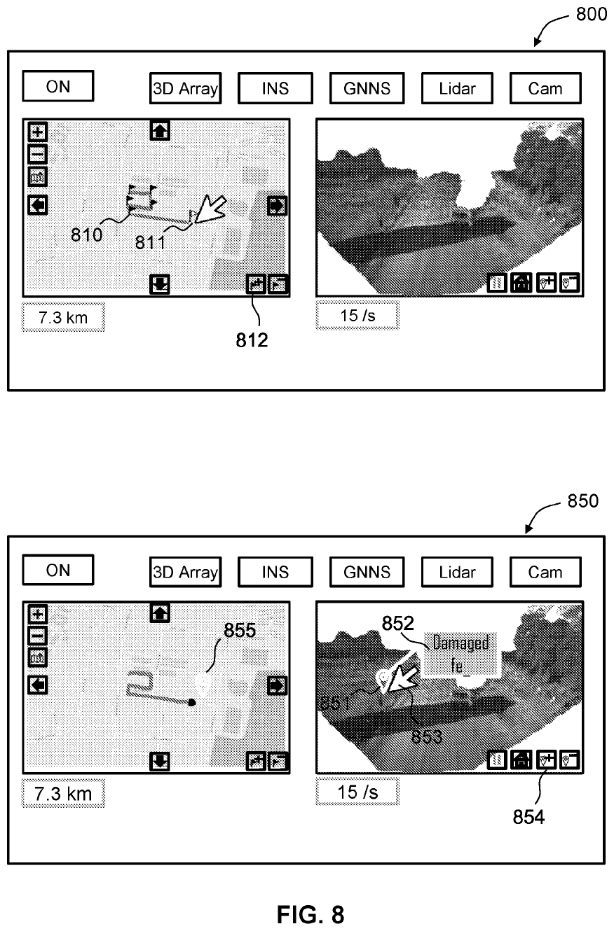

FIG. 7 shows some further examples of data frames and associated data blocks including annotation data blocks. In the element 720 a data packet 724 has the type ‘Annotation’ and the source ‘Manual’ and contains annotation as may have been made at step 260 using the user interface of the Spatial Sensor as illustrated in FIG. 8. In FIG. 7 the data for the annotation data packet is show in a breakout box at 751 and is in a JSON format and includes the information that the annotation is text, the coordinates of the annotation which may be local with respect to the location of this element 720 and the text annotation itself.

In the element 730 a data packet 734 has the type ‘Annotation’ and the source ‘Sensor AI’ and contains annotation as may have been made at step 260 by a AI engine such as an object detector and classifier. The data for the annotation data packet is show in a breakout box at 752 in a JSON format and includes the information that the annotation is an “AI Object”, that the object has been classified as a “Car” with a confidence of 83% and the coordinates of the object including.

### Sensor User Interface

FIG. 3 shows the user interface 300 for the sensor unit 110. The user interface 300 provides for control of the sensor unit 110 via control button 320 which may be used to start and stop the capture of new data. When the control button 320 is in the ON state then steps in the main flow 200 such as 220, 230, 240, and 250 may operate repeatedly to receive new data, determine the path and to multiplex the data. Also show are status indicators 321, 322, 323, 324, and 325 that may indicate the status of certain available sensors so, for example, if the camera array spatial sensor is not functioning, then the indicator 321 may be coloured red but otherwise be coloured black. On the left half of the user interface 300 a map panel 340 is displayed. In certain embodiments the map panel 340 displays pre-loaded map data. An overlay on the map panel 340 may show the travelled path as indicated at 345 and the current location of the sensor unit and its orientation may also be shown on the map panel as indicted at 346. In certain embodiments, the multiplex data contains location information and pose change data to determine the path that has been travelled and determination of the current location and orientation so that this information may be presented on the use interface as described. The map panel 340 has buttons for various functions common for a map interface including buttons to zoom in, zoom out, shift the map up, down, left and right, and to recenter the map on the current location. These controls may also be duplicated with preconfigured keys or buttons on a customised physical interface. Below the map panel 340 is a distance indicator 431 that may show the distance of travel that has been recorded. On the right half of the user interface 300 the spatial data panel 350 presents a representation of spatial information. The point of view used to present the spatial information may be changed by the user, for example, translating the view point up or down, left or right, closer or further and rotating the view point up or down, left or right. The viewpoint changes may be activated using a keyboard, a computer mouse, or other control interface. By changing the presented point of view the user may observer the spatial relationships between objects with greater clarity than is possible with a conventional image which has only two-dimensional data. The spatial data panel may represent the scene currently being observed by the sensor unit 120 and may be updated as new spatial information is generated by the Camera Array Spatial Sensor. Control button 352 may enable the user to pause the update of spatial information so that the user may change the viewpoint and study a particular instance of the spatial information. Control button 353 may enable the user to reset the viewpoint to a natural home viewpoint. In certain embodiments, the natural home viewpoint may be the viewpoint of the sensor unit. Below the spatial data panel 350 is a data rate indicator 351 that may show the frequency that spatial data is captured from the Cameras Array Spatial Sensor 1600.

FIG. 8 shows the user interface for the sensor unit 110 being operated to manually provide location information at 800 and being operated to provide spatial annotation at 850.

Referring to the user interface at 800 the user may move the pointer 811 to a location on map and may active the button 812 to mark location shown with a white flag icon. In certain embodiments, this location may be the actual location of the sensor unit 110 or as close to as the user may be determined. As shown at 810 previously placed location points are marked with black flags. The locations marked by the user may be captured in the multiplex data and used to provide initial location data or to supplement other available location data. Manual location marking may be useful where operating without access to other sources of location data such as may be obtained from a positioning system such as a Global Navigation Satellite System (GNNS).

Referring to the user interface at 850 the user may select the previously described pause button 352 to freeze the update of spatial data and may use the previously described capacity to change the point of view to help precisely identify a point in the scene 1400 that is observed by the sensor unit 150 and represented in the Spatial View panel 350. The user may use the button 854 to initiate an annotation at the identified point. As shown at 851 an annotation marker may be placed on the representation of the spatial data indicating the point in space that will be annotated. The user may enter text at 852 that will be an annotation associated with the location. In certain embodiments the annotation may be one or more of a selection of previously selected text labels or enumerated icons. In certain embodiments, the annotation may be a captured audio recording from the user. In certain embodiments, the user interface may place a marker on the map in the map panel 340 at the location of the annotation, as illustrated at 855. And in certain embodiments, the user may select such a marker 855 at a later time and the user interface may show the annotation and may show the spatial data associated with the annotation.

The spatial location of the annotation and the content of the annotation may be captured in the multiplex data. Since the annotations may be associated with an element in the multiplex data the precise location of the annotations may subsequently be presented in the user interface of the sensor unit 110, the user interface of the explorer unit 150, may exported into a suitable format for use other applications for viewing map data or viewing spatial data, or combinations thereof.

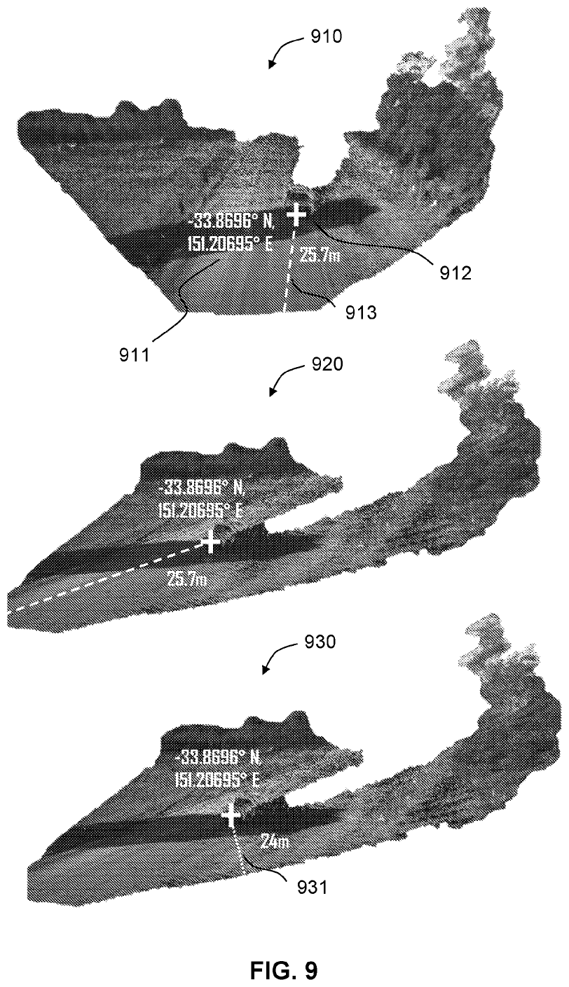

In FIG. 9 are shown some details of the user interface 300 being operated to take measurements from a scene. At 910 is a detail of the spatial data panel 350 being operated to measure the distance from the Sensor 110 to an object in the scene. The user has operated the controls of the user interface 300 to place a cursor 911 at a point of interest on an object in the scene. The user interface presents a dashed line 913 to indicates to the user that a distance from the sensor to the point of interest is being measured and the measurement of 25.7 m is shown adjacent to the dashed line. Also show to the user is the geo-referenced coordinates, in latitude and longitude, of the point in the scene represented by the location of the cursor. At 920 the user has rotated the point of view using the user interface controls and from this oblique viewing angle the user is able to verify that the cursor has been placed in the intended position on the object. At 930 the user has rotated the point of view using the user interface controls and the measurement mode has been changed to measure from origin of the new point of view to the point of interest.

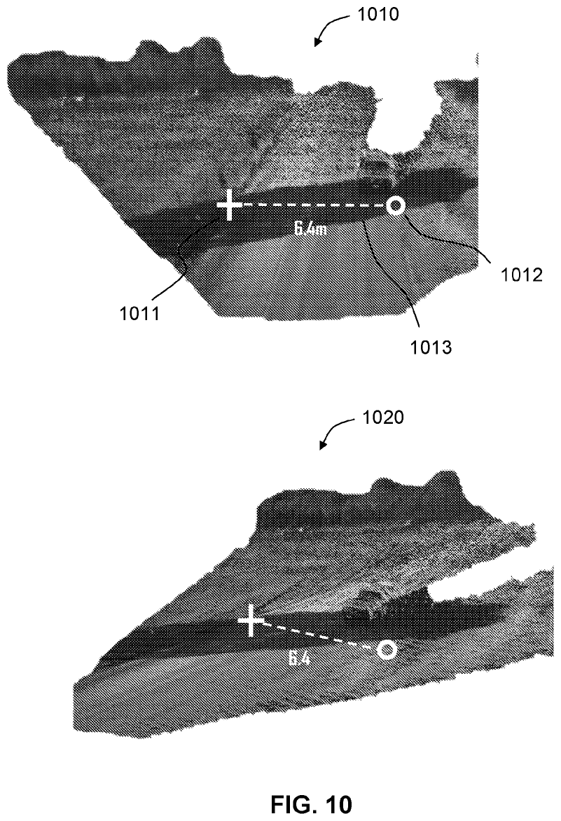

In FIG. 10 are shown some further details of the user interface 300 being operated by a user to take measurements from a scene. At 1010 the user has operated the controls of the user interface 300 to place a marker 1012 at a first point of interest in the scene and to place a cursor 1011 at a second point of interest in the scene. The user interface displays a dashed line 1013 visually indicating the interval to be measured and displays the measurement value, 6.4 m on the display. At 1020 the user has rotated the point of view using the user interface controls and from this oblique viewing angle the user is able to verify that the marker 1012 and the cursor 1011 have been placed in the intended positions in the scene.

### Explorer User Interface

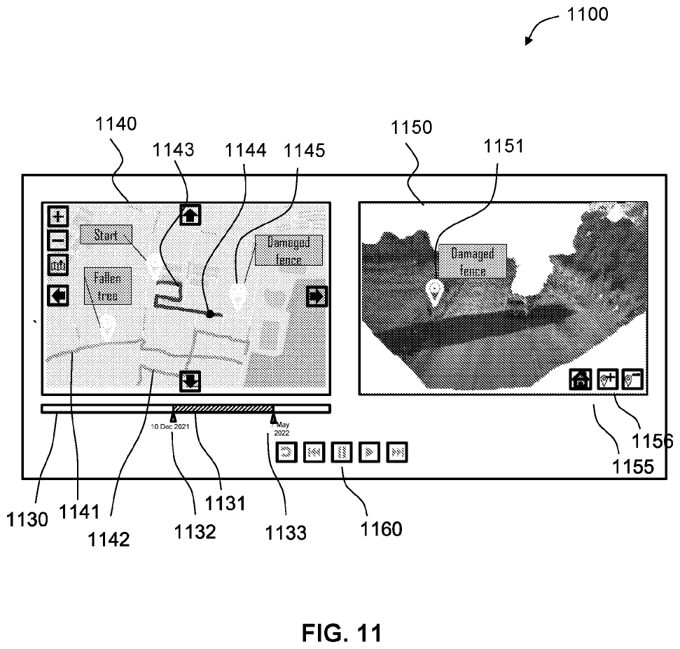

FIG. 11 shows the user interface 1100 for the explorer unit 150. On the left half of the user interface 1100 a map panel 1140 is displayed. In certain embodiments, the map panel 1140 displays pre-loaded map data sometimes known as foundation data. Below the map panel 1140 a timeline control 1130 includes a start marker 1132 and an end marker 1133 which may be dragged by a user to set a begin time and end time. The begin time and end time may be used to filter the traces that are represented on the map panel. As an example, in FIG. 11 there are three traces shown on the map at 1141, 1142, and 1143.

In certain embodiments, the trace may be coloured at one or more points along its path according to the direction of travel enabling a user to understand the path used to capture the trace. In certain embodiments, the user may select a point on a trace and the accumulated spatial information for the selected point in the selected trace may be displayed in the spatial panel 1150. The map panel 1140 may have buttons for various functions common for a map interface including buttons to zoom in, zoom out, shift the map up, down, left and right, and to recenter the map on the current location. These controls may also be duplicated with preconfigured keys or buttons on a customised physical interface. On the right half of the user interface 1100 the spatial data panel 1150 presents a representation of spatial information. The point of view used to present the spatial information may be changed by the user for example translating the view point up or down, left or right, closer or further and rotating the view point up or down, left or right. The viewpoint changes may be activated using a keyboard or a computer mouse or other control interface. By changing the presented point of view the user may observer the spatial relationships between objects with greater clarity than is possible with a conventional two-dimensional image where only one point of view is available. Control buttons 1160 may enable the user to pause and play back the original recorded trace and the user may change the viewpoint. Thus, the user may play through a trace, pause at a point of interest and study the accumulated spatial information from a selected location. Control button 1155 may enable the user to reset the viewpoint to a natural home viewpoint. In certain embodiments, the natural home viewpoint may be the viewpoint of the sensor unit at the time the spatial data was captured. Button 1156 may enable a user to add an annotation to a position in the spatial data similarly to that operation of the user interface 300 in the sensor unit and this annotation may be stored in the multiplex data of the trace that is being played.

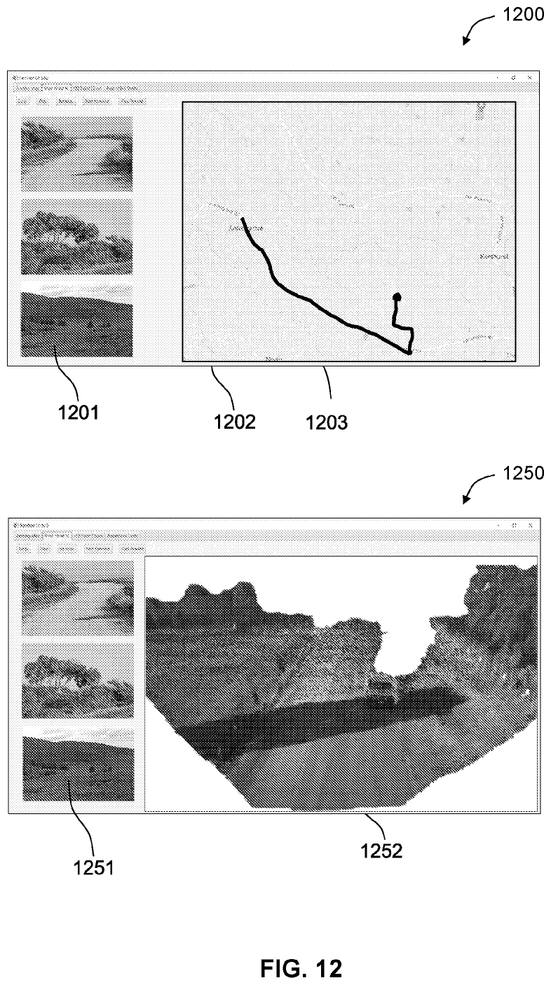

FIG. 12 at 1200 shows a user interface for the explorer unit 150 in ‘map mode’. In ‘map mode’ a map panel 1202 shows preloaded map data and the path of the recorded trace is shown at 1203. A cross indicates a position along the path and on the left is a panel of images 1201 that are images captured by the sensor unit at the indicated position. The user interface 1200 may have user controls, not illustrated, that enable the user to select positions on the path or to advance the position along the path step by step. As the position along the path changes the images at 1201 are updated. The user may select a position on the path and change the user interface to ‘playhead mode’.

FIG. 12 at 1250 shows the user interface for the explorer unit 150 in ‘playhead mode’. In ‘playhead mode’ a view of the spatial data is shown in a large panel at 1252. In certain embodiments, the spatial data is the spatial data captured from the Camera Array Spatial sensor 1600. On the left are images captured by the sensor unit at or about the same time as the spatial data. The user interface 1250 may have user controls, not illustrated, that enable the user to move through the captured spatial data and the associated image data. The spatial data panel may have user controls, not illustrated, that enable the user to change the point of view. The user may use other controls to change the user interface to ‘HD Point Cloud mode’.

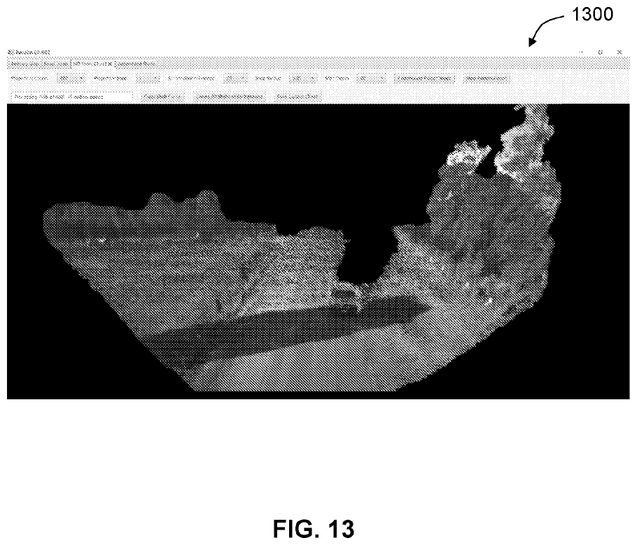

FIG. 13. at 1300 shows the user interface for the explorer unit 150 in ‘HD Point Cloud mode’. In ‘HD Point Cloud mode’ a view of accumulated spatial data is shown. The user interface 1300 may have user controls, not illustrated, that enable the user to change the point of view and move through the accumulated spatial data.

### Exemplary Illustrative Scene

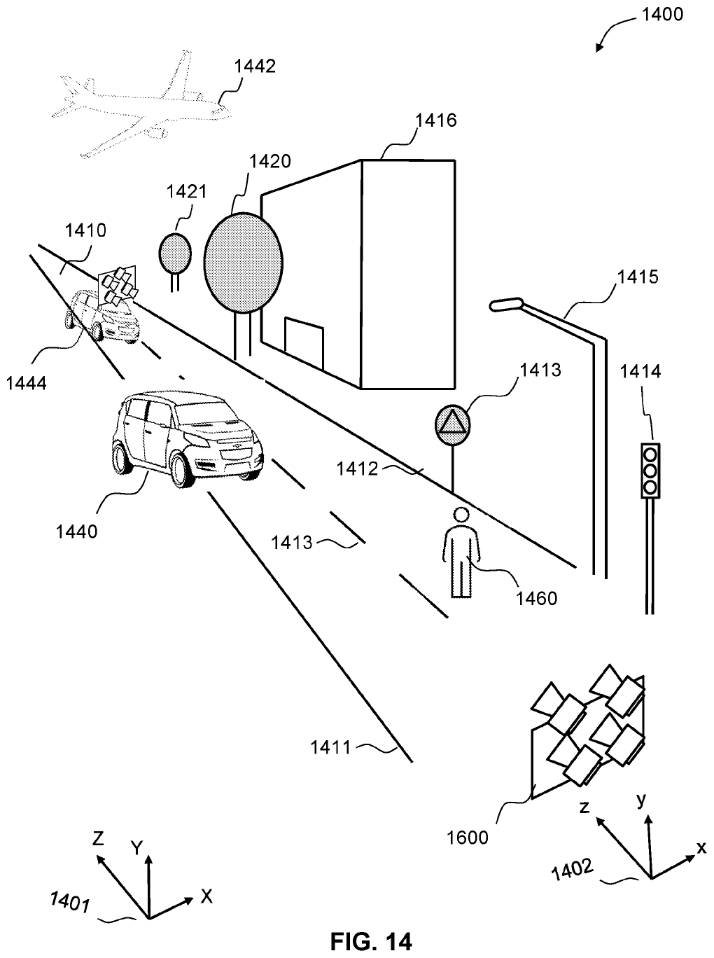

FIG. 14 shows a figurative scene 1400. The road 1410 may have visible edges 1411, 1412 and may have road marking 1413 in approximately the centre line of the road 1410. In this scene there are two cars 1440, 1444 are on the road and an airplane in the sky 1442. Also shown are trees 1420, 1421 a sign 1413 positioned to the side of the road, a streetlight 1415, a traffic light 1414 and a building 1416. A sensor system 110 is shown oriented to observe the scene. The sensor system 110 may be located on a vehicle (not shown) and may be moving through the scene. In FIG. 14 axes 1402 represent a local coordinate system of the sensor system 1402 also shown are axes 1401 representing a global coordinate system.

### Exemplary Computer System

A computer system (1500) may include a processor (1510), memory unit (1540), data storage (1520), a receiving unit (1530), and an external communication unit (1550). A computer system(1500) may include hardware for executing instructions, such as those making up a computer program. As an example, and not by way of limitation, to execute instructions, processor (1510) may retrieve the instructions from an internal register, an internal cache, memory unit (1540), or data storage (1520); decode and execute them; and then write one or more results to an internal register, an internal cache (not shown), memory unit (1540), or data storage (1520). The processor (1510) may include one or more internal caches for data, instructions, or addresses. This disclosure contemplates processor (1510) including a suitable number of suitable internal caches, where appropriate. The processor (1510) may include one or more instruction caches, one or more data caches, and one or more translation lookaside buffers (TLBs). Instructions in the instruction caches may be copies of instructions in memory unit (1540) or data storage (1520), and the instruction caches may speed up retrieval of those instructions by processor (1510).

The memory (1540) may include main memory for storing instructions for processor to execute or data for processor to operate on. The computer system (215) may load instructions from data storage (290) or another source (such as, for example, another computer system) to memory unit (1540). The processor unit (260) may then load the instructions from memory unit (1540) to an internal register or internal cache. To execute the instructions, the processor unit (260) may retrieve the instructions from the internal register or internal cache and decode them. During or after execution of the instructions, the processor unit (160) may write one or more results (which may be intermediate or final results) to the internal register or internal cache. The processor unit (260) may then write one or more of those results to the memory unit (1540). The processor unit (260) may execute only instructions in one or more internal registers or internal caches or in the memory unit (1540) (as opposed to data storage (290) or elsewhere) and operates only on data in one or more internal registers or internal caches or in memory unit (1540) (as opposed to data storage (290) or elsewhere). One or more memory buses may couple processor unit (260) to memory unit (1540). The Bus (not shown) may include one or more memory buses. The memory unit (1540) may include random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. Memory unit (1540) may include one or more memories, where appropriate.

The data storage (1520) may include mass storage for data or instructions. The data storage (1520) may include a hard disk drive (HDD), flash memory, an optical disc, a magneto-optical disc, magnetic tape, or a Universal Serial Bus (USB) drive or a combination therein. Data storage (1520) may include removable or non-removable (or fixed) media, where appropriate. Data storage (1520) may be internal or external to computer system, where appropriate. Data storage may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination thereof.

The Receiving Unit (1530) may include communicate connection (1531) to communicate data and/or control signals with a variety of devices including imaging sensors such as cameras, 3D sensors such as camera array 3D sensors, lidar or radar, navigational devices such as GNNS and INS, motion sensors such as gyroscopes, inertial sensors and odometers, environmental sensors such as barometric sensors, temperature sensors, UV sensors, heat sensors, other sensors to collect information about the local environment, or combinations thereof. The receiving Unit (1531) may use one or more suitable communication connection such as ethernet, RS232, RS488, USB, Gigabit Multimedia Serial Link (GMSL), Bluetooth, WiFi, or radio.

The external comms unit (1550) may include a communication connection (1551) to communicate data and control signals with other devices. The external comms unit (1551) may use one or more suitable communication connections such as ethernet, RS232, RS488, USB, Gigabit Multimedia Serial Link (GMSL), Bluetooth, WiFi, radio, or other.

In certain embodiments, I/O interface (not shown) may include hardware, software, or both, providing one or more interfaces for communication between computer system and one or more I/O devices. Computer system may include one or more of these I/O devices, where appropriate. One or more of these I/O devices may enable communication between a person and computer system. An I/O device may include a keyboard, keypad, microphone, monitor, mouse, printer, scanner, speaker, still camera, stylus, tablet, touch screen, trackball, video camera, another suitable I/O device, or a combination thereof. An I/O device may include one or more sensors. This disclosure contemplates any suitable I/O devices and any suitable I/O interfaces for them. Where appropriate, I/O interface may include one or more device or software drivers enabling the processor unit (1510) to drive one or more of these I/O devices. I/O interface may include one or more I/O interfaces, where appropriate.

In certain embodiments, one or more computer systems provide functionality described or shown in this disclosure. The computer systems may include specialised or bespoke computing platforms that may include custom designed processing components such as FPGA or ASIC.

In certain embodiments, software configured to be executable running on one or more computer systems performs one or more steps of one or more methods disclosed herein and/or provides functionality disclosed herein. Reference to a computer system may encompass a computing device, and vice versa, where appropriate.

This disclosure contemplates a suitable number of computer systems. As example and not by way of limitation, computer system 1500 may be an embedded computer system, a system-on-chip (SOC), a single-board computer system (SBC) (such as, for example, a computer-on-module (COM) or system-on-module (SOM)), a desktop computer system, a laptop or notebook computer system, a main-frame, a mesh of computer systems, a personal digital assistant (PDA), a server, a tablet computer system, an augmented/virtual reality device, a ruggedised computer, a military grade computer or a combination of thereof. Where appropriate, computer system 115 may include one or more computer systems; be unitary or distributed; span multiple locations; span multiple machines; span multiple data centres; or reside in a cloud, which may include one or more cloud components in one or more networks. Where appropriate, one or more computer systems 115 may perform without substantial spatial or temporal limitation one or more steps of one or more methods described or illustrated herein. As an example, and not by way of limitation, one or more computer systems 1500 may perform in real time or in batch mode one or more steps of one or more methods disclosed herein.

### Exemplary Camera Array 3d Sensor

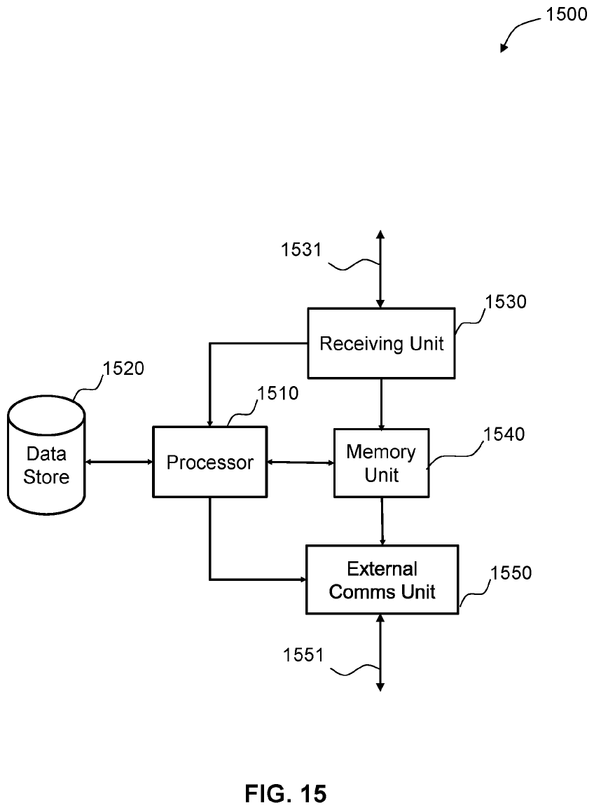

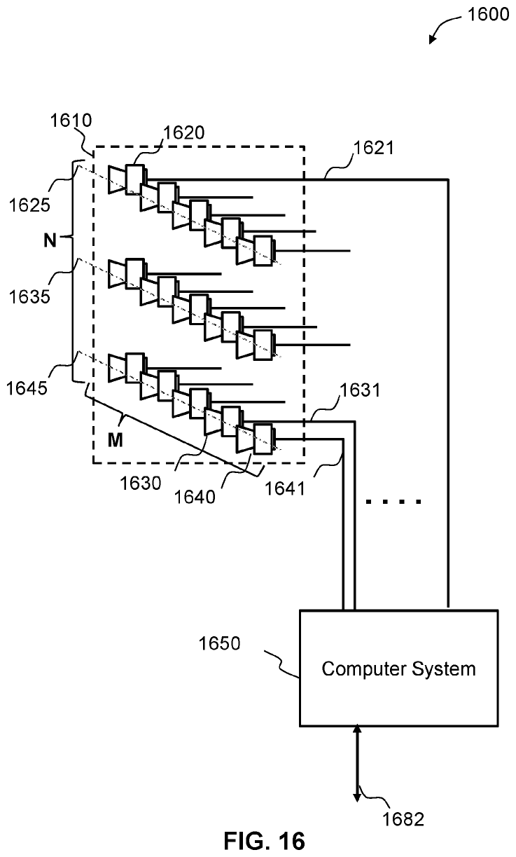

FIG. 16 shows an exemplary camera array spatial sensor 1600 that may generate spatial information. FIG. 16 includes an exemplary configuration of cameras including 1610, 1630 and 1640 on a camera platform 1610 and computer system 1650. Cameras on the camera platform 1610 may be connected (either directly or indirectly) to the computer system 1650. Cameras may have a communication channel indicated by 1621, 1631, 1641 to accept control and/or synchronisation signals and to output image data. Capture of images from one or more cameras on the camera platform 1610 may be triggered by signals sent over the communication channel 1621, 1631, 1641. In certain embodiments, Cameras external to the camera platform such as camera 114 in FIG. 1 may be connected to the computer system 1650, and in certain embodiments, these cameras may contribute to the determination of spatial information instance. In certain embodiments, the computer system 1650 may be as described a general-purpose computer system as illustrated in FIG. 15 and the associated description. In certain embodiments, the computer system may be use a CPU, GPU, ASIC, FPGA to perform information processing or may be a CPU operating in conjunction with a GPU, ASIC or FPGA to perform information processing or may be some other combination of these configured to perform the required information processing.

In certain embodiments, the relative position or orientation of cameras such as 1620, 1630 and 1640 on the camera platform 210 may be known. In certain embodiments, the cameras on the camera platform may have a trigger (not shown) that enables image frames to be captured at specific times, or synchronised so that the camera capture data at substantially the same time for all or most of the cameras making up the camera platform.

In certain embodiments, the camera platform may include related circuitry (not shown) to ensure capture of images from cameras on the camera platform at times controlled by external systems.

In certain embodiments cameras such as 1610, 1630 and 1640 maybe conventional cameras sensitive to the visible light spectrum in three colour bands or may be other camera or camera like sensors that are sensitive to other bands of the electromagnetic spectrum for example devices that sense in infra-red (IR), short wave infra-red (SWIR), or in multiple spectrum or any 2 d imaging device.

### EXAMPLES

Further advantages of the claimed subject matter will become apparent from the following examples describing certain embodiments of the claimed subject matter.

Example 1. A system for generation of spatial annotations comprising:
at least one camera array comprising at least 2 cameras;
   wherein the camera array is configured to generate spatial information instance data;
a computer system that is configured to:
   capture a plurality of spatial information instance data and one or more of the following: image data, sensor data, and user entered data;
   and associate the one or more of the following: image data, sensor data, and user entered data with the plurality spatial information instance data captured.
2. A system for generation of spatial annotations comprising:
at least one camera array comprising at least 4, 5, 6, 8, 10, 12, 14, or 16 cameras;
   wherein at least 4 cameras, of the at least one camera array, is a sensor that is sensitive to an electromagnetic spectrum and configured to generate spatial information instance data;
a computer system that is configured to:
   capture a plurality of spatial information instance data and one or more of the following: image data, sensor data, and user entered data;
   determine a path for the plurality spatial information instance data captured; and
   associate the one or more of the following: image data, sensor data, and user entered data with the plurality spatial information instance data captured.
3. The system for generation of spatial annotations of examples 1 or 2, wherein the computer system is further configured to determine one or more pose changes using one or more of the following: image data and spatial information instance data; and
compute the path using the one or more pose changes.
4. The system for generation of spatial annotations of any of the examples 1 to 3, wherein the computer system further comprises a user interface that is configured to:
allow an annotation with a location in three-dimensions, and present spatial information where the user interface permits changing the point of view, and where the user interface permits a user to select a point or surface represented in the spatial information that is representative of a physical surface in the spatial information;
wherein the user interface permits the user to associate a point or surface with an annotation.
5. The system for generation of spatial annotations of any of examples the 1 to 4, wherein a computer is configured to: operate on information from the sensor to identify an object of interest, and permits an annotation for a location in three-dimensions using information from the computer system.
6. The system for generation of spatial annotations of examples 1 or 2, wherein the computer system further comprises a user interface that is configured to:
determine a geo-referenced location from at least one reference point with a known geo-referenced location and one or more pose changes, wherein the one or more pose changes is determined using one or more of the following: spatial data and image data;
present spatial information where the user interface that allows for changing the point of view, and allow a user to select a point or surface represented in the spatial information that is representative of a physical surface in the spatial information, and allows the user to associate a point or surface with an annotation.
7. A method for generation of spatial annotations using any of the systems in examples 1 to 6.
8. One or more computer-readable non-transitory storage media embodying software that is operable when executed using any of the systems or methods in examples 1 to 6.

While certain embodiments have been shown and described herein, it will be obvious to those skilled in the art that such embodiments are provided by way of example only.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear. It is to be understood that the present disclosure is not limited to the disclosed embodiments, and is intended to cover various modifications and equivalent arrangements included within the spirit and scope of the present disclosure. Also, the various embodiments described above may be implemented in conjunction with other embodiments, e.g., aspects of one embodiment may be combined with aspects of another embodiment to realize yet other embodiments. Further, independent features of a given embodiment may constitute an additional embodiment.

1-8. (canceled)

9. A system for generation of spatial annotations comprising: at least one camera array comprising at least 2 cameras;
wherein the camera array is configured to generate spatial information instance data; a computer system that is configured to:
capture a plurality of spatial information instance data and one or more of the following: image data, sensor data, and user entered data;
and associate the one or more of the following: image data, sensor data, and user entered data with the plurality spatial information instance data captured.

10. The system for generation of spatial annotations of claim 9, wherein the computer system is further configured to determine one or more pose changes using one or more of the following: image data and spatial information instance data; and
compute a path using the one or more pose changes.

11. The system for generation of spatial annotations of claim 9, wherein the computer system further comprises a user interface that is configured to:
allow an annotation with a location in three-dimensions, and present spatial information where the user interface permits changing a point of view, and where the user interface permits a user to select a point or surface represented in the spatial information that is representative of a physical surface in the spatial information;
wherein the user interface permits the user to associate the point or surface with an annotation.

12. The system for generation of spatial annotations of claim 9, wherein a computer is configured to: operate on information from a sensor to identify an object of interest, and permits an annotation for a location in three-dimensions using information from the computer system.

13. The system for generation of spatial annotations of claim 9, wherein the computer system further comprises a user interface that is configured to:
determine a geo-referenced location from at least one reference point with a known geo-referenced location and one or more pose changes, wherein the one or more pose changes is determined using one or more of the following: spatial data and image data;
present spatial information where the user interface that allows for changing a point of view, and allow a user to select a point or surface represented in the spatial information that is representative of a physical surface in the spatial information, and allows the user to associate the point or surface with an annotation.

14. A method for generation of spatial annotations using the system of claim 9.

15. One or more computer-readable non-transitory storage media embodying software that is operable when executed using the system of claim 9.

16. A system for generation of spatial annotations comprising:
at least one camera array comprising at least 4, 5, 6, 8, 10, 12, 14, or 16 cameras; wherein at least 4 cameras, of the at least one camera array, is a sensor that is sensitive to an electromagnetic spectrum and configured to generate spatial information instance data;
a computer system that is configured to:
capture a plurality of spatial information instance data and one or more of the following: image data, sensor data, and user entered data;
determine a path for the plurality spatial information instance data captured; and associate the one or more of the following: image data, sensor data, and user entered data with the plurality spatial information instance data captured.

17. The system for generation of spatial annotations of claim 16, wherein the computer system is further configured to determine one or more pose changes using one or more of the following: image data and spatial information instance data; and
compute the path using the one or more pose changes.

18. The system for generation of spatial annotations of claim 16, wherein the computer system further comprises a user interface that is configured to:
allow an annotation with a location in three-dimensions, and present spatial information where the user interface permits changing a point of view, and where the user interface permits a user to select a point or surface represented in the spatial information that is representative of a physical surface in the spatial information;
wherein the user interface permits the user to associate the point or surface with an annotation.

19. The system for generation of spatial annotations of claim 16, wherein a computer is configured to: operate on information from the sensor to identify an object of interest, and permits an annotation for a location in three-dimensions using information from the computer system.

20. The system for generation of spatial annotations of claim 16, wherein the computer system further comprises a user interface that is configured to:
determine a geo-referenced location from at least one reference point with a known geo-referenced location and one or more pose changes, wherein the one or more pose changes is determined using one or more of the following: spatial data and image data;
present spatial information where the user interface that allows for changing a point of view, and allow a user to select a point or surface represented in the spatial information that is representative of a physical surface in the spatial information, and allows the user to associate the point or surface with an annotation.

21. A method for generation of spatial annotations using the system of claim 16.

22. One or more computer-readable non-transitory storage media embodying software that is operable when executed using the system of claim 16.
